(19) United States
(12) Patent Application Publication
(10) Pub. No.: US 2005/0016153 A1
(43) Pub. Date: Jan. 27, 2005

(54) Rake attachment

(76) Inventor: Geoffrey Samuel Baker, Mandurah (AU)

Correspondence Address: Jeffrey M Kaden;Gottlieb Rackman & Reisman, 270 Madison Avenue, New York, NY, 10016-0601, US

(21) Appl. No.: 10/489,993

(22) PCT Filed: Aug. 30, 2002
(86) PCT No.: PCT/AU02/01202

(30) Foreign Application Priority Data
Sep. 19, 2001 (AU) PR7798
Nov. 23, 2001 (AU) PR9107

(51) Int. Cl. A01D 7/00

(52) U.S. Cl. 56/400.12

(57) ABSTRACT

An attachment adapted to be connected to a rake (10) having a rake head (13) and a handle (11) comprising a body (15) adapted to cooperate with the rake head (13) to provide an enclosure, the body (15) pivotally supported from the rake head (13) and the handle (11) to be moveable between a first position wherein the body (15) is supported clear of the rake head (13) substantially parallel and closely adjoining the handle (11) and a second position wherein the body (15) is positioned to cooperate with the rake head (13) to provide the enclosure.

### FIELD OF THE INVENTION

The present invention relates to a rake attachment.

Throughout the specification, the term “rake” will be used to refer to any device having a handle and a head wherein the head is adapted for gathering material over which it is passed and will be taken to include lawn rakes and brooms. Throughout the specification, unless the context requires otherwise, the word “comprise” or variations such as “comprises” or “comprising”, will be understood to imply the inclusion of a stated integer or group of integers but not the exclusion of any other integer or group of integers.

### BACKGROUND ART

Typically, a rake is used to gather debris into a pile which is then shifted into a container for disposal by use of either another tool such as a shovel or by hand. This has disadvantages in that either additional expense is incurred in purchasing a second tool and time is taken in changing tools, or the task is more laborious and the hands of the worker are exposed to hazards that may be in the debris.

### DISCLOSURE OF THE INVENTION

Accordingly, the present invention resides in an attachment adapted to be connected to a rake; the rake comprising a rake head and a handle, the attachment comprising a body adapted to cooperate with the rake head to provide an enclosure, the body pivotally supported from the rake head and the handle to be moveable between a first position wherein the body is supported clear of the rake head substantially parallel and closely adjoining the handle and a second position wherein the body is positioned to cooperate with the rake head to provide the enclosure.

According to a preferred feature of the invention, the body in its movement between the first position and the second position is movable through an intermediate position wherein the forward edge of the body is positioned adjacent the surface to be raked.

According to a preferred feature of the invention, in its movement between the first position and the second position, the body rotates to move into cooperating relationship with the rake head at the first position. According to a preferred feature of the invention, the rotational movement of the body provides a scooping action by the body. According to a preferred embodiment, the scooping action is provided principally in the movement of the body between the intermediate position and the second position. According to a preferred feature of the invention, the body remains substantially parallel to the handle during movement of the body between the first position and the intermediate position.

According to a preferred feature of the invention, the means for pivotally supporting the body from the rake head comprises a link means pivotally engaging the rake head and the body.

According to a preferred embodiment, the link means comprises a pair of link members.

According to a preferred embodiment, the manner of engagement of the link means with the body is the same as the manner of engagement of the link means with the rake head.

According to a preferred embodiment, the body may be manufactured from the same mould as the rake head.

According to a preferred embodiment, the enclosure is provided by the arrangement of the body with respect to the rake head such as to provide an acute angle between the body and the rake head extending from an axis adjacent the front edges of the body and the rake head, the body being adapted to be movable.

According to a preferred feature of the invention, the body is supported from the rake by support means which limits the extent of forward movement of the body.

According to a preferred feature of the invention, the body is supported by a control link connected to a grip supported from the handle, the grip being movable along the handle to control movement of the body, between the first and second positions.

According to a preferred embodiment, the grip is provided with means to maintain alignment of the control link with the handle while the grip is moved along the handle.

According to a preferred embodiment, the means to maintain alignment of the link comprises a means to prevent rotation of the grip about the handle while the grip is moved along the handle.

The invention will be more fully understood in the light of the following description of several specific embodiments.

### BRIEF DESCRIPTION OF THE DRAWINGS

The description is made with reference to the accompanying drawings, of which:

FIG. 1 is a perspective view of a rake attachment mounted to a rake in accordance with the first embodiment of this invention.

FIG. 2 is a side elevation of a rake attachment mounted to a rake in which the body of the rake attachment is in a first position in accordance with the first embodiment of this invention;

FIG. 3 is a side elevation of a rake attachment mounted to a rake in which the body of the rake attachment Is in an intermediate position In accordance with the first embodiment of this invention;

FIG. 4 is a side elevation of a rake attachment mounted to a rake in which the body of the rake attachment is in a second position In accordance with the first embodiment of this invention;

FIG. 5 is a side elevation of a rake attachment mounted to a rake in which the body of the rake attachment is in a first position in accordance with the second embodiment of this invention; and

FIG. 6 is a side elevation of a rake attachment mounted to a rake in which the body of the rake attachment is in an intermediate position in accordance with the second embodiment of this invention.

FIG. 7 is a perspective view of a rake attachment mounted to a rake in accordance with the second embodiment of this invention.

FIG. 8 is a perspective view of a rake attachment mounted to a rake in accordance with the third embodiment of this invention.

FIG. 9 is a side elevation of a rake attachment mounted to a rake in which the body of the rake attachment is in a first position in accordance with the third embodiment of this invention;

FIG. 10 is a side elevation of a rake attachment mounted to a rake in which the body of the rake attachment is in an intermediate position in accordance with the third embodiment of this invention; and

FIG. 11 is a side elevation of a rake attachment mounted to a rake in which the body of the rake attachment is in a second position in accordance with the third embodiment of this invention.

FIG. 12 is an perspective view of a fourth embodiment of a rake attachment mounted;

FIG. 13 is a side elevation of a rake attachment mounted to a rake as shown in FIG. 12, the body of the rake attachment being shown in a first position;

FIG. 14 is a side elevation of a rake attachment mounted to a rake as shown in FIG. 12, the body of the rake attachment being shown in an intermediate position;

FIG. 15 is a side elevation of a rake attachment mounted to a rake as shown in FIG. 12, the body of the rake attachment being shown in a second position;

FIG. 16 an isometric enlargement of a portion of the handle of the rake as shown in FIG. 12 showing the grip of the attachment to the rake, the grip being shown in a first position;

FIG. 17 is a front end view of the grip as shown in FIG. 17;

FIG. 18 a further isometric enlargement of a portion of the handle of the rake as shown in FIG. 16 showing the grip of the attachment to the rake, the grip being shown in a second position;

FIG. 19 is a front end view of the grip as shown in FIG. 18;

FIG. 20 is a font elevation of second link as used in the fourth embodiment;

FIG. 21 is a side elevation of the second link as shown in FIG. 20.

FIG. 22 is an perspective view of a rake attachment mounted to a rake in accordance with the fifth embodiment of this invention in which the body of the rake attachment is in a first position;

FIG. 23 is a perspective of a rake attachment mounted to a rake in accordance with the fifth embodiment of this invention in which the body of the rake attachment is in an intermediate position;

FIG. 24 is a perspective of a rake attachment mounted to a rake in accordance with the fifth embodiment of this invention in which the body of the rake attachment is in a second position;

FIG. 25 is a side elevation of a rake attachment mounted to a rake in which the body of the rake attachment is in a first position in accordance with the fifth embodiment of this invention;

FIG. 26 is a side elevation of a rake attachment mounted to a rake in which the body of the rake attachment is In an intermediate position in accordance with the fifth embodiment of this invention;

FIG. 27 is a side elevation of a rake attachment mounted to a rake in which the body of the rake attachment is in a second position in accordance with the fifth embodiment of this invention;

FIG. 28 is a sectional view of a rake attachment mounted to a rake in accordance with the fifth embodiment of this invention;

### DETAILED DESCRIPTION OF SPECIFIC EMBODIMENTS

The embodiments of the invention are directed to a rake attachment for a lawn rake which enables debris to be gathered by the rake after it has been raked into a pile.

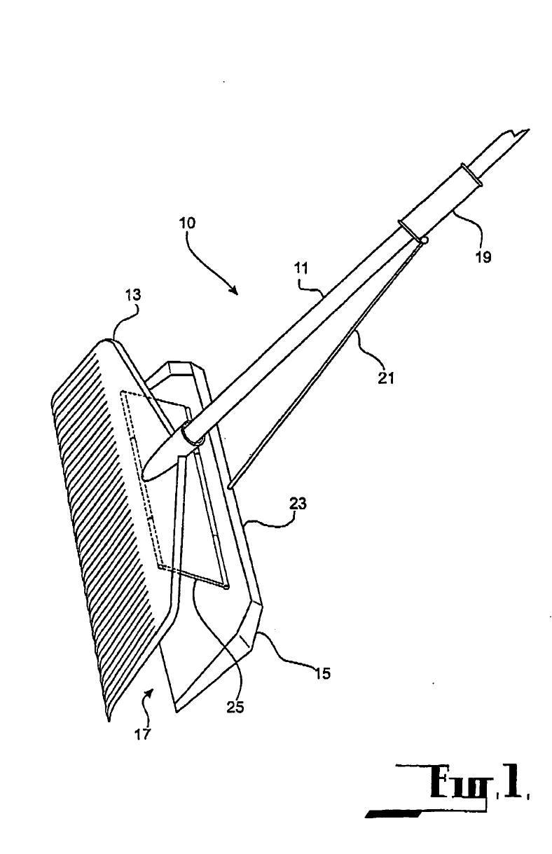

The first embodiment of a rake attachment is illustrated in FIGS. 1, 2, 3 and 4 as being mounted to a lawn rake 10 where the rake 10 is of a substantially conventional form and comprises a handle 11 and a head 13 provided at one end of the handle 11.

The rake attachment comprises a body 15.

The body 15 has a configuration which is similar to that of the head 13 and in use is supported from the rake 10 by a mounting to be able to be moved to a position at which it can cooperate with the head 13 of the rake 10 to gather debris. To effect this the face of the body 15 which is directed towards the head 13 has a scoop-like configuration with a front edge 17 whereby the front edge 17 is able to cooperate with the outer ends of the tines of the head 13 of the rake 10 to collect debris.

The mounting includes a rake attachment grip 19 and a first link 21 which pivotably connects the body 15 to the rake attachment grip 19.

The rake attachment grip 19 is of tubular configuration and is slidably received on the handle 11.

The first link 21 takes the form of an elongate member which is pivotably connected at one end to the rake attachment grip 19 and is pivotably connected at its other end to the rear 23 of the body 15.

The mounting further comprises a second link 25 which takes the form of a substantially rectangular frame which is pivotably mounted at one side to the head 13 of the rake 10 and is pivotably mounted at the opposed side to the body 15 intermediate of the front edge 17 and the rear 23 of the body 15.

The mounting enables movement of the body 15 relative to the rake 10 between a first position at which the body 15 is closely adjacent the handle 11 and clear of the head 13 such that the body 15 does not interfere with the manipulation of the rake 10 by a user or the raking motion of the head 13 and a second position at which the body 15 cooperates with the head 13 to define an enclosure wherein on movement between the first and second position the body 15 passes through an intermediate position at which the body 15 is in spaced opposed relation to the head 9.

In use, when debris is to be gathered, the rake attachment grip 19 is initially drawn towards the end of the handle 11 remote from the head 13. This movement of the rake attachment grip 19 causes the body 15 to be drawn up to the first position at which the body 15 is closely adjacent the handle 11 and clear of the head 13 such that the body 15 does not interfere with the manipulation of the rake 10 by a user or the raking motion of the head 13, as illustrated in FIG. 2.

The head 13 is then manipulated by the user in known manner to rake the debris into a pile.

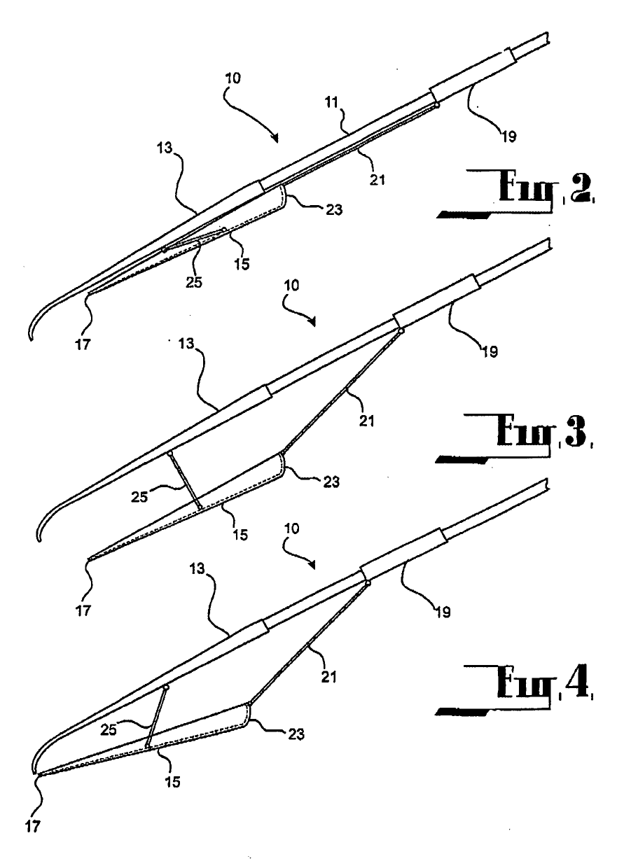

Once the desired amount of debris has been piled together, the head 13 is positioned on the pile, and the rake attachment grip 19 is pushed towards the head 13, as illustrated in FIG. 3. This movement of the rake attachment grip 19 causes the body 15 to move through the intermediate position at which the body 15 is in spaced opposed relation to the head 13.

As the body 15 is moved, debris is scooped up and trapped between the body 15 and the head 13 as the body 15 is moved to the second position at which the body 15 cooperates with the head 13 to define an enclosure comprising the head 13 and the body 15, as illustrated in FIG. 4.

The debris trapped in the enclosure between the body 15 and the head 13 may then be released into a container for disposal by again drawing the rake attachment grip 19 towards the end of the handle 11 remote from the head 13.

This process is repeated until all of the desired debris has been placed into the container for disposal.

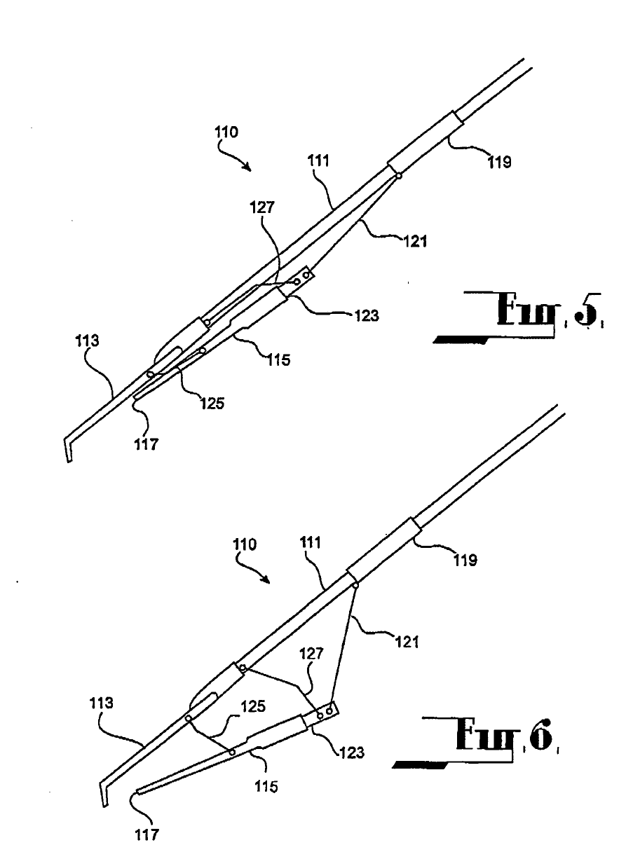

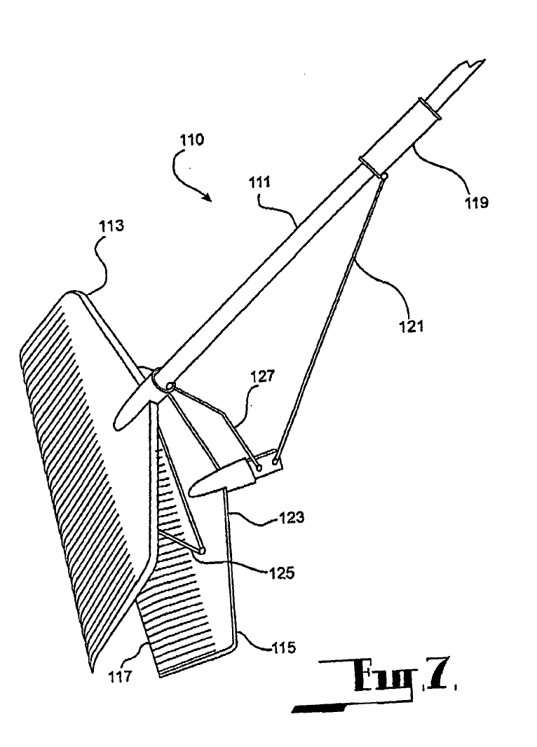

The second embodiment of a rake attachment is illustrated in FIGS. 5, 6 and 7 as being mounted to a lawn rake 110 where the rake 110 is of substantially conventional form and comprises a handle 111 and a head 113 provided at one end of the handle 111.

The rake attachment comprises a body 115.

The body 115 has a configuration which is similar to that of the head 113 and in use is supported from the rake 110 by a mounting to be able to be moved to a position at which it can cooperate with the head 113 of the rake 110 to gather debris. To effect this the body has a tined front edge 117 whereby the tined front edge 117 is able to cooperate with the outer ends of the tines of the head 113 of the rake 110 to collect debris.

The mounting includes a rake attachment grip 119 and a first link 121 which pivotably connects the body 115 to the rake attachment grip 119.

The rake attachment grip 119 is of tubular configuration and is slidably received on the handle 111.

The first link 121 takes the form of an elongate member which is pivotably connected at one end to the rake attachment grip 119 and is pivotably connected at its other end to the rear 123 of the body 115.

The mounting further comprises a second link 125 which takes the form of a substantially rectangular frame which is pivotably mounted at one side to the head 113 of the rake 110 and is pivotably mounted at the opposed side to the body 115 intermediate of the tined front edge 117 and the rear 123 of the body 115.

The mounting further comprises a third link 127 which takes the form of an elongate member having a bend at a substantially central portion of its length which is pivotably connected at one end to the handle 111 of the rake 110 substantially near the head 113 of the rake 110 and is pivotably connected at its other end to the rear 123 of the body 115 substantially near the pivoted connection between the body 115 and the first link 121.

The mounting enables movement of the body 115 relative to the rake 110 between a first position at which the body 115 is closely adjacent the handle 111 and clear of the head 113 such that the body 115 does not interfere with the manipulation of the rake 110 by a user or the raking motion of the head 113 and a second position at which the body 115 cooperates with the head 113 to define an enclosure wherein on movement between the first and second position the body 115 passes through an intermediate position at which the body 115 is in spaced opposed relation to the head 113.

The third link 127 of the mounting enables the body 115 to be co-planar with the head 113 of the rake 110 when in the first position and enables an enclosure to be formed having an acute angle between the tined front edge 117 of the body 115 and the outer end of the tines of the head 113 of the rake 110 when In the second position. The third link 127 further enables the distance between the head 113 of the rake 110 and the rear 123 of the body 115 to be kept constant as the body passes through the intermediate position.

In use, when debris is to be gathered, the rake attachment grip 119 is initially drawn towards the end of the handle 111 remote from the head 113. This movement of the rake attachment grip 119 causes the body 115 to be drawn up to the first position at which the body 115 is co-planar with the head 113 of the rake 110 and closely adjacent the handle 111 and clear of the head 113 such that the body 115 does not interfere with the manipulation of the rake 110 by a user or the raking motion of the head 113, as illustrated in FIG. 5.

The head 113 is then manipulated by the user in known manner to rake the debris into a pile.

Once the desired amount of debris has been piled together, the head 113 is positioned on the pile, and the rake attachment grip 119 is pushed towards the head 113, as Illustrated In FIG. 6. This movement of the rake attachment grip 119 causes the body 115 to move through the intermediate position at which the body 115 is in spaced opposed relation to the head 119. The distance between the head 113 of the rake 110 and the rear 123 of the body 115 is kept constant as the body passes through the intermediate position by the action of the third link 127.

As the body 115 is moved, debris is scooped up and trapped between the body 115 and the head 113 as the body 115 is moved to the second position at which the body 115 cooperates with the head 113 to define an enclosure comprising the head 113 and the body 115 having an acute angle between the tined front edge 117 of the body 115 and the outer end of the tines of the head 113 of the rake 110.

The debris trapped in the enclosure between the body 115 and the head 113 may then be released into a container for disposal by again drawing the rake attachment grip 119 towards the end of the handle 111 remote from the head 113.

This process is repeated until all of the desired debris has been placed into the container for disposal.

The third embodiment of a rake attachment is illustrated in FIGS. 8, 9, 10 and 11 as being mounted to a lawn rake 210 where the rake 210 is of a substantially conventional form and comprises a handle 211 and a head 213 provided at one end of the handle 211.

The rake attachment comprises a body 215.

The body 215 has a configuration which is similar to that of the head 213 and in use is supported from the rake 210 by a mounting to be able to be moved to a position at which it can cooperate with the head 213 of the rake 210 to gather debris. To effect this the body 215 has a tined front edge 217 whereby the tined front edge 217 is able to cooperate with the outer ends of the tines of the head 213 of the rake 210 to collect debris.

The mounting includes a rake attachment grip 219 and a first link 221 which connects the body 215 to the rake attachment grip 219.

The rake attachment grip 219 is of tubular configuration and is slidably received on the handle 211.

The first link 221 takes the form of an elongate member which is pivotably connected at one end to the rake attachment grip 219 and is pivotably connected at its other end to the rear side of the body 215.

The mounting further comprises a second link 225 which takes the form of a pair of substantially identical “U”-shaped frames. Each frame of the second link 225 comprises a crosspiece and two substantially identical arms 240 extending substantially parallel to each other from each end of the cross piece, wherein each arm is angled along its length to provide a first section 240a and a second section 240b.

The frames of the second link 225 are spaced across the head 213 of the rake 210 and are each pivotably mounted at the free ends of the arms to the head 213 of the rake 210 and are each pivotably mounted at the crosspiece to the body 215 adjacent the pivotable connection of the first link 221 with the body 215. A coil spring 224 is connected between the first link 221 intermediate its ends and the rear edge of the body 215 in order that the front edge 217 of the body 215 is resiliently biased away from the tines of the head 213.

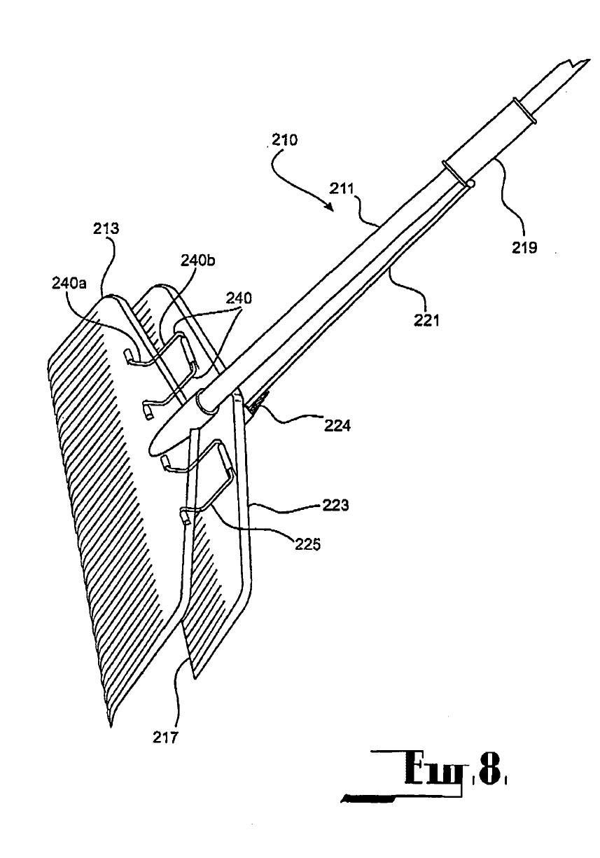

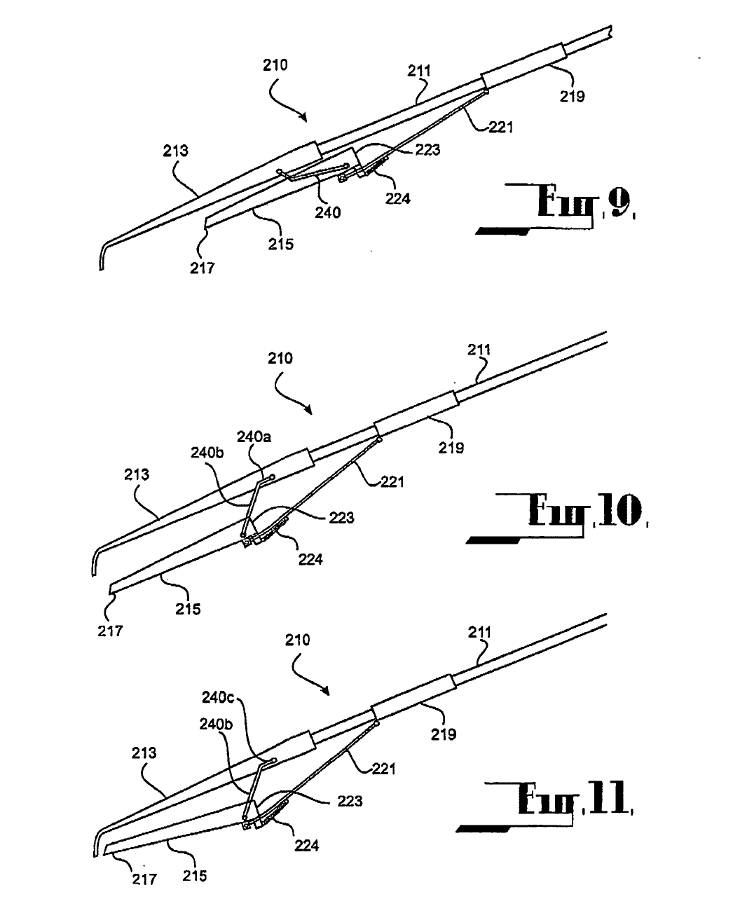

The mounting enables movement of the body 215 relative to the rake 210 between a first position (as shown at FIG. 9) at which the body 215 is closely adjacent the handle 211 and clear of the head 213 such that the body 215 does not interfere with the manipulation of the rake 210 by a user or the raking motion of the head 213 and a second position (as shown at FIG. 11) at which the body 215 cooperates with the head 213 to define an enclosure wherein on movement between the first and second position the body 215 passes through an intermediate position (as shown at FIG. 10) at which the body 215 is in spaced opposed relation to the head 213.

When the body 215 is moved from the first position through the intermediate position the angle formed between the first sections 240a of the arms 240 of the second link 225 and the head 213 is decreased until the first section 240a of the arms 240 of the second link 225 abut the head 213. Once this position is reached, the distance between the head 213 and the body 215 is kept constant about the second link 225 while the body 215 pivots about the second link 225 towards the second position. This enables an enclosure to be formed having an acute angle between the tined front edge 217 of the body 215 and the outer end of the head 213 when in the second position, as illustrated in FIG. 11.

In use, when debris is to be gathered, the rake attachment grip 219 is initially drawn towards the end of the handle 211 remote from the head 213. This movement of the rake attachment grip 219 causes the body 215 to be drawn up to the first position at which the body 215 is closely adjacent the handle 211 and clear of the head 213 such that the body 215 does not interfere with the manipulation of the rake 210 by a user or the raking motion of the head 213, as illustrated in FIG. 9.

The head 213 is then manipulated by the user in known manner to rake the debris into a pile.

Once the desired amount of debris has been piled together, the head 213 is positioned on the pile, and the rake attachment grip 219 is pushed towards the head 213, as illustrated in FIG. 10. This movement of the rake attachment grip 219 causes the body 215 to move through the intermediate position to the second position as described above.

As the body 215 is moved, debris is scooped up and trapped between the body 215 and the head 213.

The debris trapped in the enclosure between the body 215 and the head 213 may then be released into a container for disposal by again drawing the rake attachment grip 219 towards the end of the handle 211 remote from the head 213, wherein the spring 224 ensures effective opening of the enclosure by biasing the front edge 217 of the body 215 away from the head 213.

This process is repeated until all of the desired debris has been placed into the container for disposal.

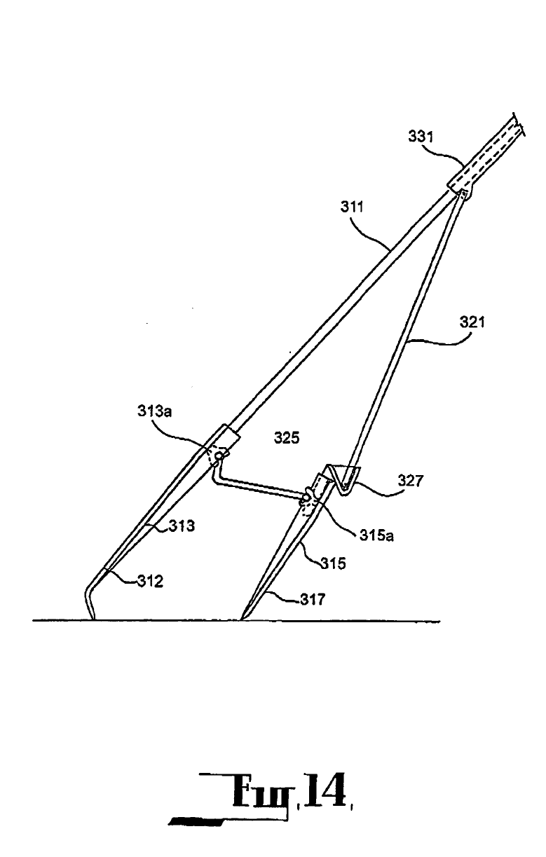

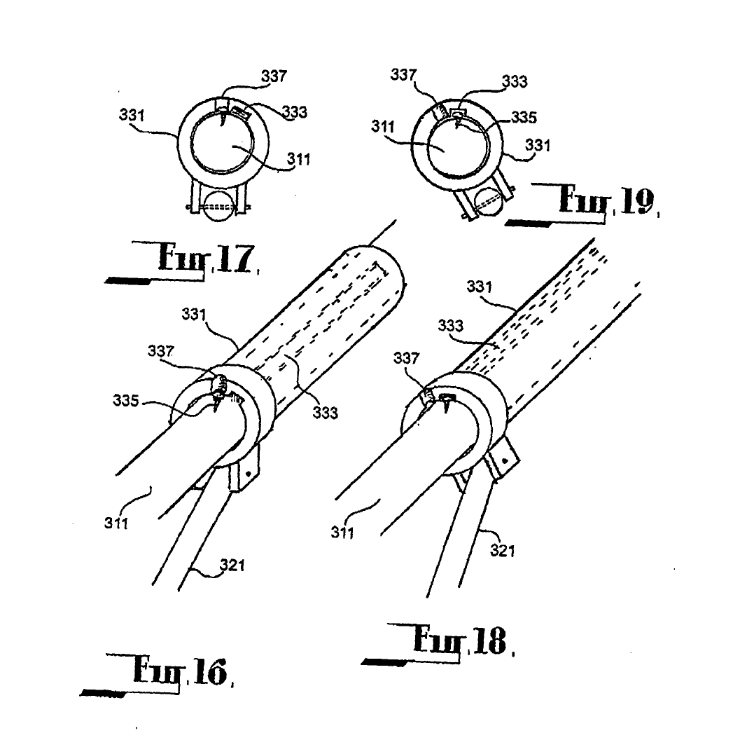

The fourth embodiment of a rake attachment is illustrated in FIGS. 12, 13, 14, 15, 16, 17, 18, 19, 20 and 21 as being mounted to a lawn rake 310 where the rake 310 is of a substantially conventional form and comprises a handle 311 and a head 313 provided at one end of the handle 311. The fourth embodiment is similar to that of the third embodiment but incorporates several refinements which improve the use of the device. The rake head 313 is manufactured from plastics material and comprises an array of tines 312 at the front end thereof and a moulded cylindrical aperture 314 at the centre of the rear thereof, the cylindrical aperture 314 adapted to receive the handle 311.

The rake head 313 is manufactured from plastics material and comprises an array of tines 312 at the front end thereof and a moulded cylindrical aperture 314 at the centre of the rear thereof, the cylindrical aperture 314 adapted to receive the handle 311.

The rake attachment comprises a body 315. The body 315 has a configuration which is similar to that of the head 313 and is also made from plastics material.

The body 315 comprises an array of tines 317 at the front which are of shorter length than those of the tines 312 of the rake head 313. The body 315 further comprises a moulded cylindrical aperture 316 at the centre of the rear of the body 315.

The body 315 is mounted to the rake by a mounting comprising a rake attachment grip 331 and a first link 321 which connects the body 315 to the rake attachment grip 331 and a pivotable second link 325 pivotably engaging the rake head 313 and the body 315. The pivotable second link 325 comprises a pair of link members in the form of substantially identical frames which engage link mountings 313a integrally moulded and laterally spaced in the rake head 313 and corresponding link mountings 315a integrally moulded in the body 315.

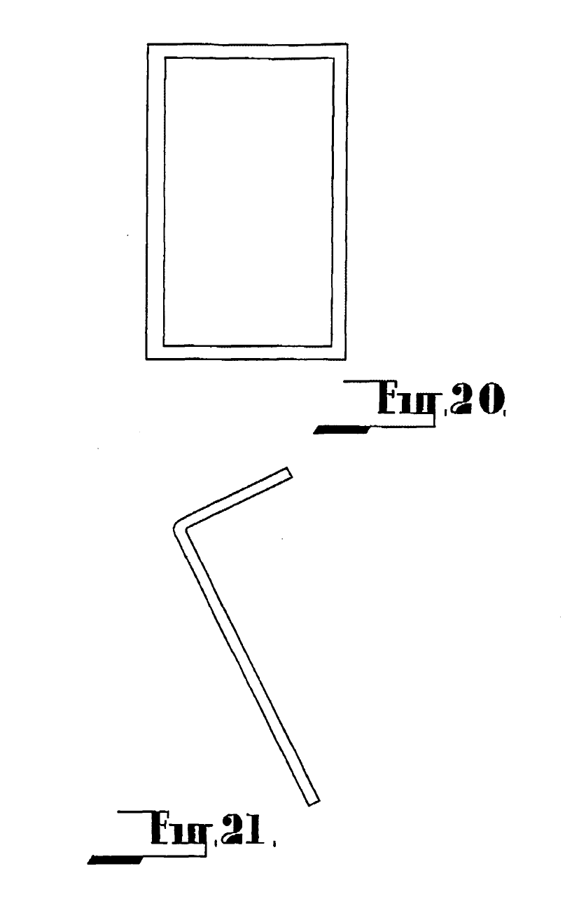

The frames of the second link 325 are rectangular in elevation, as shown in FIG. 20, each having a first cross-arm adapted to be received in a link mounting 313a, a second cross-arm adapted to be received in a link mounting 315a and a pair of side-arm. The side-arms have an “L” shaped profile as shown in FIG. 21, each side-arm having a first sub-arm and a second-sub arm. The first sub-arm is configured to contact the rake head 313, thereby limiting rotation of the second link 325 about the link mounting 313a in the link head 313, and thereby limiting movement of the body 315 relative to the rake head 313.

At this stage, in may be noted that the configuration of the body 315 and that of the rake head 313 are substantially identical, both having a body with a moulded cylindrical aperture at the rear, a pair of moulded link mountings and an array of tines, the only difference, being that the tines 317 of the body 315 are shorter than the tines 312 of the head 313. By careful design and according to a preferred adaption of the embodiment, the body and the head are configured such that they are manufactured from the same mould, a blanking piece being inserted into the mould during the manufacture of the body 315. In this way, tooling costs for the assembly are reduced considerably.

The rake attachment grip 331 is of tubular configuration and is slidably received on the handle 311. As shown in FIGS. 16, 17, 18 and 19, the grip is provided with a longitudinal groove 333 extending substantially for the full length of the grip in the interior surface of the grip 331. A guide pin 335 extends from the handle 311 and is adapted to be received within the groove 333 of the grip 331, thereby preventing the grip 331 from being rotated about the handle 3i 1 while the grip is slidably moved forwardly or backwardly. This configuration ensures that the first link 321 is aligned with the handle 311 while the link is moved forwardly or rearwardly which alignment is desirable to ensure that the link does not jam during movement.

The grip 331 is provided with a notch 337 radially extending along the forward surface of the grip 331. The notch 337 is positioned adjacent to the groove 333 and is adapted to receive the guide pin 335 In use, when the body 315 is not in use, the grip 331 is moved rearwardly until the grip 331 is slightly behind the guide pin 335. The grip 331 is then rotated to align the notch 337 with guide pin 335 and the grip 331 moved forwardly to engage the notch 337 with the guide pin 335, thereby restaining the grip 331 from rotational movement. Due to the weight of the body 315 biasing the grip 331 in a forward direction, the engagement of the notch 337 with the guide pin 335 ensures that the grip 331 does not rotate during raking which would allow the guide pin 335 to be received in the groove 333, thereby allowing the grip 331 and the body 315 to move forwardly.

The first link 321 takes the form of an elongate member which is pivotably connected at one end to the grip 331 and is pivotably connected at its other end to a link attachment 327 at the rear of the body 315. The link attachment 327 comprises a member having a cylindrical support 330 adapted to be received in the cylindrical aperture 316 of the body 315 and having a walled link opening 328 adapted to receive the first link 321 between the walls of the opening 328, a link pin 329 being receivable within apertures in the walls, the link pin 329 being adapted to engage the other end of the first link 321. The pivotable connection of the first link 321 with the link attachment 327 permits pivotable movement of the first link 321 with respect to the body 315 while the body 315 is moved.

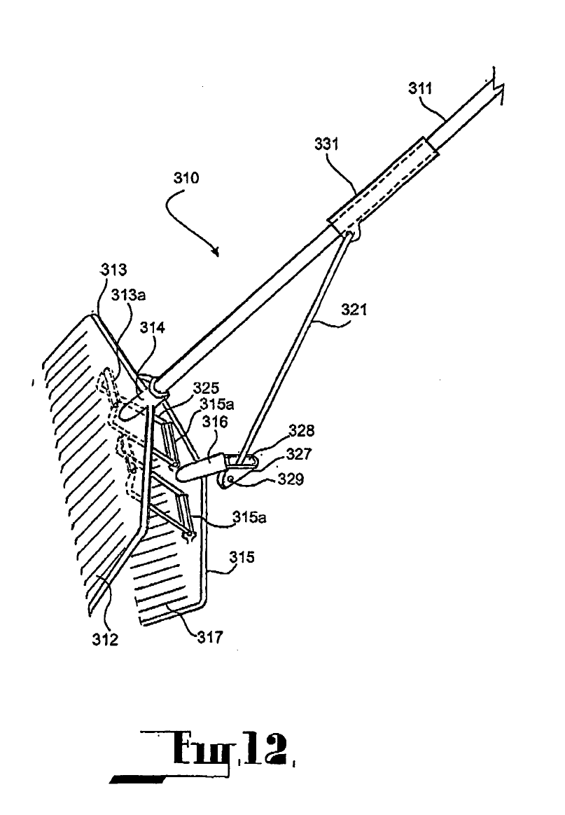

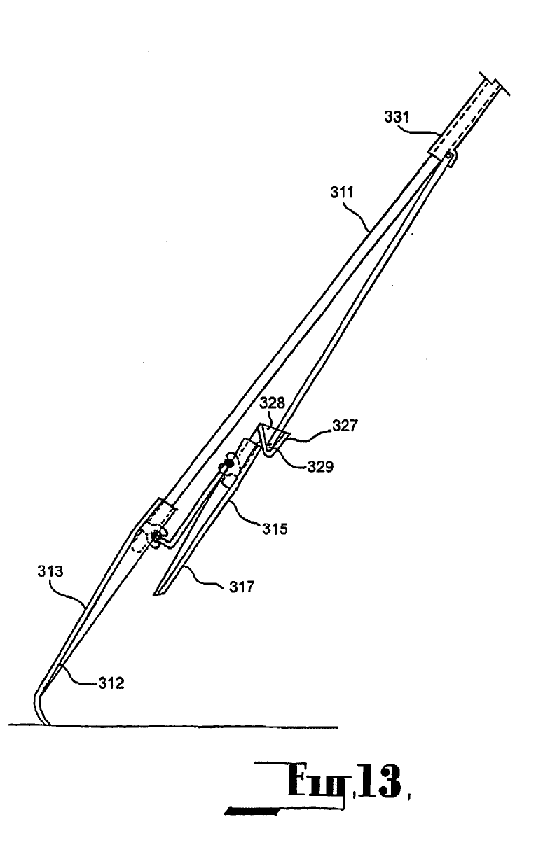

The walled link opening 328 of the link attachment 327 limits movement of the body 315 relative to the rake 310 between a first position (as shown at FIG. 13) at which the body 315 is closely adjacent the handle 311 and clear of the head 313 such that the body 315 does not interfere with the manipulation of the rake 310 by a user or the raking motion of the head 313 and a second position (as shown at FIG. 15) at which the body 315 cooperates with the head 313 to define an enclosure wherein on movement between the first and second position the body 315 passes through an intermediate position (as shown at FIG. 14) at which the body 315, in use, is arranged adjacent the surface to be raked.

In use, while debris is to be gathered, the body 315 is located in the first position, as shown in FIG. 13, secured by the notch 337 in the grip 331 engaging the guide pin 335. In this position, the body 315 lies closely adjacent to and substantially parallel with the handle 311, thereby limiting to a minimum any obstruction caused by the body 315 during the raking process.

Once the desired amount of debris has been piled together, the grip 331 is rotated to enable the guide pin to be received in the groove 333 allowing the grip 331 to be moved forwardly, thereby providing forward movement to the first link 321 and the body 315. The body is thereby moved to an intermediate position at which it is adjacent to the surface being raked, the head 313 being positioned on the pile which has been gathered.

As the body 315 is moved beyond the intermediate position towards the second position, the body 315 is caused to rotate relative to the first link 321 due to the geometry of the configuration. This rotational motion during the forward movement provides a scooping action which greatly enhances the collection of the debris between the body 315 and the rake head 313. The rotational displacement is such that when the body 315 lies in the second position, the ends of the tines 317 being adjacent the ends of the tines 314 of the rake head 313, an enclosure is formed to retain the debris, the enclosure having an acute angle between the tines 314 of the rake head 313 and the tines 314 of the body 315.

The trapped debris is transported and deposited by withdrawing the body 315 from the head 313 by pulling back the grip 331 along the handle 311.

It should be noted that it is a particular feature of each of the embodiments that the body of the rake attachment when In the first, withdrawn position lies closely adjacent to and substantially parallel with the rake handle, thereby limiting to a minimum any obstruction caused by the body during the raking process. When the body is moved towards an intermediate position, it does so in a way whereby it remains in an orientation substantially parallel to the handle, again minimising any potential interference with the surface being raked or any adjacent obstruction. Finally, as the body is moved towards its second position having the forward edge adjacent the forward edge of the rake head, the orientation of the body is rotated relative to the rake head and to form an enclosure at the second position where the body is arranged substantially at an acute angle to the rake head about the forward edge of the rake head.

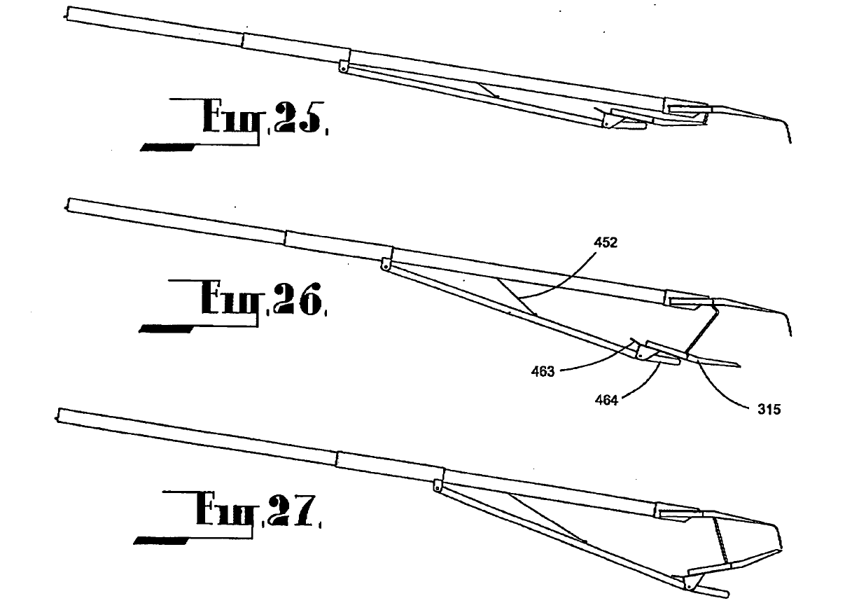

A fifth embodiment of a rake attachment is illustrated in FIGS. 22, 23, 24, 25, 26, 27 and 28 as being mounted to a lawn rake 310 where the rake 310 is of a substantially conventional form and comprises a handle 311 and a head 313 provided at one end of the handle 311. The fifth embodiment is very similar to that of the fourth embodiment but incorporates several further refinements and therefore in the drawings like components are denoted with like numerals. The embodiment will be described by reference to those differences of significance from the fourth embodiment.

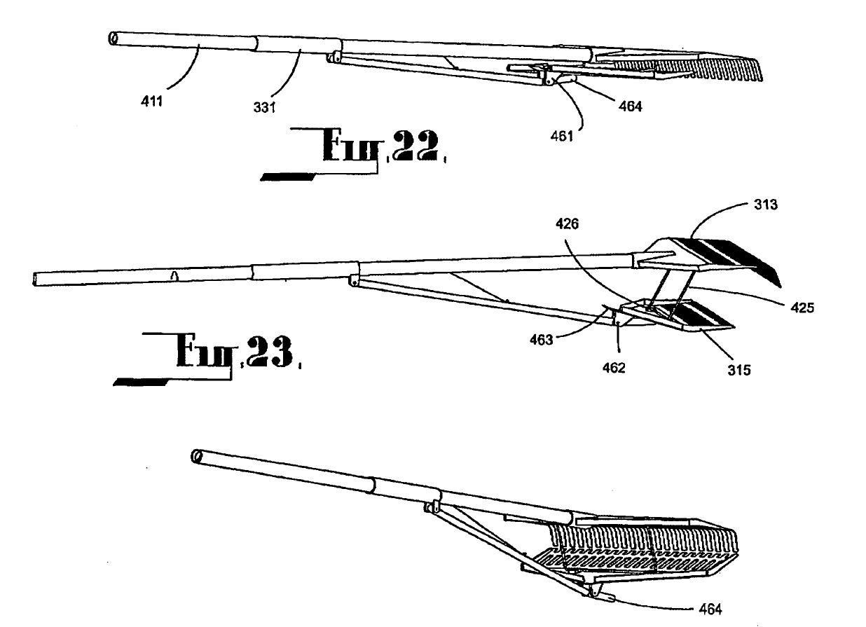

As is best seen in FIGS. 23 and 24, in the fifth embodiment, the body 315 is attached to the rake head 313 by a single pivotable second link 425, rather than by a pair of links. The second link 425 comprises a frame similar to that of each second link 325 but having a single broad cross-arm 426 adapted to engage pivot supports on the body 315 and feet members at the ends of the frame adapted to engage pivot supports in the rake head 313. The broad cross arm 426 allows the second link 425 to be connected to the each half portion of the body 315 and the rake head 313. This arrangement has been found to provide a more stable mechanism than when a pair of links are used, and are also is less expensive to manufacture.

Also in the fifth embodiment and as best seen in FIG. 28, there is provided a tubular handle 411 adapted to receive a resilient means in the form of a coil spring 451. An outer end of the spring is connected to the handle while the inner end is attached to a connecting means in the form of a length of metallic or nylon wire 452 which passes out of the handle through an orifice 453 intermediate the ends of the handle to be attached to the first link 321, intermediate its ends to thereby bias the link 321 towards the first position. In use, by pushing the grip 331and thereby the first link 321 to thereby move the body 315 toward the second position, the spring 451 Is tensioned and thereby tends to return the body 315 to the first position. In this embodiment, use of the spring 451 removes the need for spring 224, which has been found prone to damage in its more exposed position.

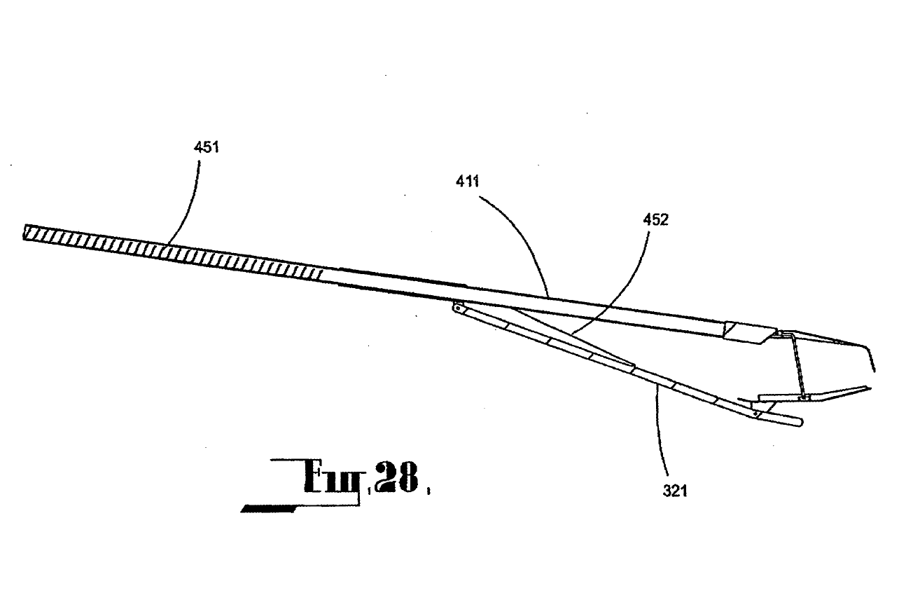

Also in the fifth embodiment, the link attachment 427 is a relatively simple mechanism comprising a pair of parallel planar arms 461 with aligned orifices 462 adapted to support the first link 321 by a link pin 329 and is preferably moulded integrally with the body 315. The link attachment 427 also incorporates a tang 463 extending out from the link attachment 427. As shown in FIG. 24 and 27, the tang 463 is adapted to contact the handle 411 and thereby limit the rotational movement of the body 315 relative to the handle 411 and thereby relative to the rake head 313.

As shown in FIG. 22 and 26, the first link 321 is provided with a link extension 464 adapted to limit rotation of the body 315 away from the rake head 313 while the body is being moved between the first position and the second position.

Also because of the tension of the coil spring and because the first link 321 cannot rotate because of its mounting to the link attachment, it has been found that it is unnecessary to provide a lock to prevent rotation of the grip. The grip can therefore be of quite simple construction.

It should be appreciated that the scope of the present invention need not be limited to the particular scope of the embodiments described above.

1. an attachment adapted to be connected to a rake; the rake comprising a rake head and a handle, the attachment comprising a body and a grip, the grip adapted to be mounted to the rake and to be moveable relative to the handle and the body adapted to be mounted to the rake to be pivotally supported from the rake to cooperate with the rake head to provide an enclosure, the attachment including a pivot link and a control link, the pivot link comprising at least one link member having two ends, one end pivotally mounted to the rake head and the other end pivotally mounted to the body, and the control link providing connection between the grip and the body, said relative movement of the grip being able to control movement of the body between a first position wherein the body is supported clear of the rake head and substantially parallel and closely adjacent the handle and a second position wherein the body is positioned to cooperate with the rake head to provide the enclosure:

2. An attachment as claimed at claim 1 wherein the body, in its movement between the first position and the second position, is movable through an intermediate position wherein the forward edge of the body is positioned adjacent the surface to be raked.

3. An attachment as claimed at claim 1 wherein in its movement between the first position and the second position, the body rotates to move into cooperating relationship with the rake head at the first position.

4. An attachment as claimed in claim 3 wherein the rotational movement of the body provides a scooping action by the body.

5. An attachment as claimed in claim 4 wherein the scooping action is provided principally in the movement of the body between the intermediate position and the second position.

6. An attachment as claimed in claim 1 wherein the body remains substantially parallel to the handle during movement of the body between the first position and the intermediate position.

7. An attachment as claimed in claim 1 wherein the body is resiliently biased towards the first position.

8. An attachment as claimed in claim 1 wherein the grip is moveable along the handle.

9. An attachment as claimed in claim 1 wherein the pivot link comprises a pair of link members.

10. An attachment as claimed in claim 1 wherein the manner of engagement of the pivot link with the body is the same as the manner of engagement of the pivot link with the rake head.

11. An attachment as claimed in claim 1 wherein the body may be manufactured from the same mould as the rake head.

12. An attachment as claimed in claim 1 wherein the enclosure is provided by the arrangement of the body with respect to the rake head such as to provide an acute angle between the body and the rake head extending from an axis adjacent the forward edges of the body and the rake head, the body being adapted to be movable.

13. An attachment as claimed in claim 1 wherein the body is supported from the rake by support means which limits the extent of forward movement of the body.

14. An attachment as claimed in claim 1 wherein the grip is provided with means to maintain alignment of the control link with the handle while the grip is moved along the handle.

15. An attachment as claimed in claim 14 the means to maintain alignment of the link comprises a means to prevent rotation of the grip about the handle while the grip is moved along the handle.

16-17. (Cancelled)

18. A rake comprising an attachment as claimed claim 1.
